(19) United States
(12) Patent Application Publication
(10) Pub. No.: US 2019/0391979 A1
(43) Pub. Date: Dec. 26, 2019

(54) USING SEGMENTS TO IMPROVE ACCESS SPEED IN BLOCKCHAIN NETWORKS

(71) Applicant: Anami Holdings, Inc., Corona, CA (US)

(72) Inventor: Adam T. Bistram, Corona, CA (US)

(21) Appl. No.: 16/443,956

(22) Filed: Jun. 18, 2019

Related U.S. Application Data
(60) Provisional application No. 62/690,287, filed on Jun. 26, 2018.

(51) Int. Cl. G06F 16/2453; G06F 16/23; G06F 16/27

(52) U.S. Cl. CPC G06F 16/24549; G06F 16/27; G06F 16/2379

(57) ABSTRACT

A system for using segments to improve access speed in a blockchain network includes at least one non-transitory storage medium that stores instructions and at least one processor that executes the instructions to create a first segment for a blockchain; upon occurrence of a triggering condition, create a second segment for the blockchain, the second segment associated with a different portion of the blockchain than the first segment; receive a search query for the blockchain that is associated with a date or a block number; and select the first segment or the second segment to search using the date or a block number of the search query. In some implementations, the at least one processor may add a branch to one or more of the segments before adding an additional set of data. The system may use the branch to search the segment rather than search from the additional set of data.

### CROSS-REFERENCE TO RELATED APPLICATION(S)

This application is a nonprovisional patent application of and claims the benefit of U.S. Provisional Patent Application No. 62/690,287, filed Jun. 26, 2018 and titled “Using Segments to Improve Access Speed in Blockchain Networks,” the disclosure of which is hereby incorporated herein by reference in its entirety.

### FIELD

The described embodiments relate generally to blockchain networks. More particularly, the present embodiments relate to blockchain networks that use segments for faster access.

### BACKGROUND

Blockchains are decentralized and distributed databases or digital ledgers that are used to record transactions across many computers. The blockchain includes a list of records, referred to as “blocks,” that may be linked and secured using cryptography. Each block may include a cryptographic hash of the previous block, a timestamp, and transaction data. The blockchain may be managed by a peer-to-peer network collectively adhering to a protocol for inter-node communication and validation of new blocks.

Each node in the network may store a complete copy of the entire blockchain. When a transaction is submitted, nodes of the network may come to a consensus according to the protocol regarding whether or not to validate the transaction. If so, the validated transaction may be added to the blockchain as a new block and propagated to storage throughout the network.

Once recorded, data in a block may be unable to be altered retroactively without alteration of all subsequent blocks, which may require collusion of a network majority. Thus, the decentralization and consensus may provide high fault tolerance and resistance to unauthorized modification. This may allow participants in the blockchain network to verify and audit transactions inexpensively and reliably.

### SUMMARY

The present disclosure relates to a blockchain network that uses segments for faster access to blocks in a blockchain. When the blockchain is first created, the network may create a first segment for the blockchain and read and/or write to the segment. When various conditions occur, the network may archive the segment and create a new segment. Thus, each segment may correspond to a portion of the blockchain of a certain time/date or block number range. As time/date or block number may be part of the key used to search for a block, the network may use the time/date or block number for a read and/or a write to select the segment where that time/date or block number may be found. The network may then search using the selected segment. When certain conditions occur, the network may create a branch on a segment, mirroring a portion of the most recent portion of the segment. When an additional set of data is added to the segment, the branch may be used instead of the last block of the additional set of data to search the segment without searching back through the additional set of data. This may further improve search time.

In various implementations, a system for using segments to improve access speed in a blockchain network includes at least one non-transitory storage medium that stores instructions and at least one processor. The at least one processor executes the instructions to create a first segment for a blockchain; upon occurrence of a triggering condition, create a second segment for the blockchain, the second segment associated with a different portion of the blockchain than the first segment; receive a search query for the blockchain that is associated with a date or a block number; and select the first segment or the second segment to search using the date or the block number of the search query.

In some examples, the triggering condition is expiration of a time period. In various implementations of such an example, the time period is approximately three months. In other examples, the triggering condition is a size of the first segment exceeding a size threshold. In some implementations of such an example, the at least one processor checks if the size of the first segment exceeds the size threshold upon expiration of a time period.

In numerous examples, upon occurrence of an additional triggering condition, the at least one processor creates a third segment for the blockchain. The third segment may be associated with a first portion of the blockchain that is associated with the first segment and a second portion of the blockchain that is associated with the second segment.

In various examples, upon occurrence of an additional triggering condition, the at least one processor adds a branch to the first segment prior to adding a set of data to the first segment. The at least one processor may be operable to search the first segment prior to the set of data using the branch.

In some implementations, a system for using segments to improve access speed in a blockchain network includes at least one non-transitory storage medium and at least one processor. The at least one non-transitory storage medium stores instructions and a group of segments that each correspond to different portions of a blockchain. The at least one processor executes the instructions to receive a query to search for a block of the blockchain, select a segment of the group of segments using a date or a block number corresponding to the query, and search the segment of the group of segments for the block.

In various examples, the group of segments correspond to all of the blockchain. In some examples, the group of segments overlap each other. In various examples, at least one of the group of segments is an archive segment.

In numerous examples, the different portions all have a same duration. In various examples, the different portions all have a same size. In some examples, the query is a read query or a write query.

In numerous implementations, a system for using segments to improve access speed in a blockchain network includes at least one non-transitory storage medium that stores instructions and at least one processor. The at least one processor executes the instructions to create a first segment associated with a first portion of a blockchain; at a first time, create a second segment associated with a second portion of the blockchain that is subsequent to the first time; at a second time, create a third segment associated with a third portion of the blockchain that is subsequent to the second time; close the first segment so the first portion of the blockchain is previous to the second time; receive a query for a block of the blockchain; and select the first segment, the second segment, or the third segment to search for the block using data specified in the query.

In some examples, the first segment overlaps the second segment and the second segment overlaps the third segment. In various examples, the at least one processor creates a fourth segment associated with a fourth portion of the blockchain at a fourth time and closes the second segment so the second portion of the blockchain is previous to the fourth time.

In various examples, the first time is a first period of time after the first segment is created and the second time is a second period of time after the first time. In some implementations of such examples, the first period of time is equal to the second period of time. In other implementations of such examples, the first period of time and the second period of time have different durations.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example of a blockchain network system.

FIG. 1B depicts an example of functional relationships between components of a node that may be used in the blockchain network system of FIG. 1A.

FIG. 2 depicts an example of a hyperledger fabric blockchain network system.

FIG. 3A depicts an example blockchain including a first segment created at a first time by a blockchain network, such as the blockchain network of FIG. 1A or the hyperledger fabric blockchain network of FIG. 2.

FIG. 3B depicts the blockchain of FIG. 3A after the blockchain network adds a first additional set of data and a branch to the first segment at a second time.

FIG. 3C depicts the blockchain of FIG. 3B after the blockchain network adds a second additional set of data to the first segment and creates a second segment at a third time.

FIG. 3D depicts the blockchain of FIG. 3C after the blockchain network archives the first segment and adds a third additional set of data and a branch to the second segment at a fourth time.

FIG. 3E depicts the blockchain of FIG. 3D after the blockchain network adds a fourth additional set of data to the second segment and creates a third segment at a fifth time.

FIG. 3F depicts the blockchain of FIG. 3E after the blockchain network archives the second segment and adds a fifth additional set of data to the third segment and creates a fourth segment at a fourth time.

FIGS. 4A and 4B depict a flow chart illustrating a first example method for using segments in a blockchain network. This method may be performed by the systems of FIG. 1A or 2.

FIG. 5 depicts a flow chart illustrating an example method for searching in a blockchain network that uses segments. This method may be performed by the systems of FIG. 1A or 2.

FIG. 6 depicts a flow chart illustrating a second example method for using segments in a blockchain network. This method may be performed by the systems of FIG. 1A or 2.

FIG. 7 depicts a flow chart illustrating a third example method for using segments in a blockchain network. This method may be performed by the systems of FIG. 1A or 2.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Blockchain networks may frequently search for blocks in the blockchain in order to read and/or write transaction data. Searching may be performed from the most recent block of the blockchain backwards until the searched block is found. The time to search may increase as the size of the blockchain increases. The frequency of searching given the volume of reads and/or writes in a blockchain network may result in overall blockchain network searching time increasing exponentially as the individual block search time increases due to larger blockchain sizes.

For example, blockchain sizes in some blockchain networks result in block creation time of several minutes to multiple hours. Some blockchain networks may be able to accept such long wait times. For example, multiple hour wait times may not be an issue in a thirty day escrow system. However, even wait times of multiple minutes may be unacceptable in real time systems, such as real time commercial transaction systems. Search times may need to be reduced in order to make blockchain networks feasible for some real time system applications.

One solution could involve ending a blockchain network after a period of time or after the blockchain of the blockchain network reaches a certain size and creating a new blockchain network. However, use of multiple blockchain networks would quickly complicate an implementation. Many of the advantages, such as data completeness and reliability, could be lost or significantly impaired by using multiple blockchain networks to prevent the size of a single blockchain from growing unfeasibly large.

The following disclosure relates to blockchain networks that use segments for faster access. When the blockchain is first created, the network may create a segment for the blockchain and read and/or write to the segment. When various conditions occur, the network may archive or close the segment and create a new segment. Thus, each segment may correspond to a portion of the blockchain of a certain time/date or block number range. As time/date or block number may be part of the key used to search for a block, the network may use the time/date or block number for a read and/or a write to select the segment where that time/date or block number may be found. The network may search using the selected segment.

Thus, by searching a segment rather than the entire blockchain each time, the network may be able to perform reads and/or writes significantly faster. This may greatly increase the response time of the network, as well as improving efficiency and reducing resources that are consumed by the network. This unconventional application of blockchain segments may address the blockchain network technology centered problem of large blockchain searching time that is in fact created by an overwhelming amount of data made possible by the blockchain network.

When certain conditions occur, the network may create a branch on a segment, mirroring a portion of the most recent portion of the segment. When an additional set of data is added to the segment, the branch may be used instead of the last block of the additional set of data to search the segment without searching back through the additional set of data. This may further improve search time.

In a particular embodiment, a blockchain network may create a first segment when the blockchain is created. The network may then read from and/or write to the first segment. After a first period of time, the network may create a second segment. The network may then read from and/or write to the second segment. The network may also read from and/or write to the first segment. Thus, the first segment may correspond to the portion of the blockchain prior to the expiration of the first period of time and the first and second segments both correspond to the portion of the blockchain after the expiration of the first period of time. After a second period of time, the network may archive or close the first segment and create a third segment. The network may then read from and/or write to the second and third segments. This may repeat after the expiration of each period of time.

In various embodiments, the time period may be the same each time. For example, the network may create new segments and/or archive or close old segments every three months. In other examples, the time period may vary. For example, the network may create a new segment every month if the size of a current segment exceeds a size threshold, such as one gigabyte. However, if the size of the current segment does not exceed the size threshold after a month, the network may omit creating a new segment and check again after another month. In still other examples, the network may create a new segment whenever a current segment exceeds a size threshold regardless of the amount of time that has elapsed since the current segment was created.

In some examples of such an embodiment, the network may add branches to one or more of the segments. The network may add a branch to one or more of the segments based on the expiration of another time period, size of the segments, and so on.

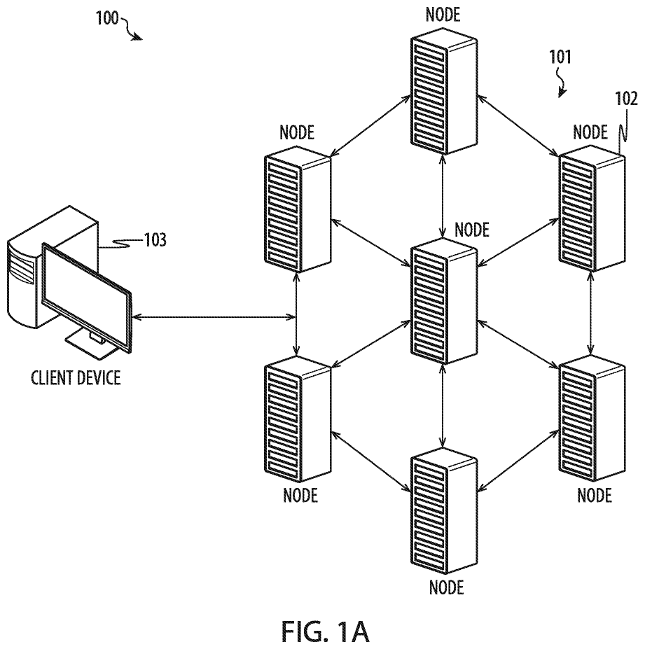

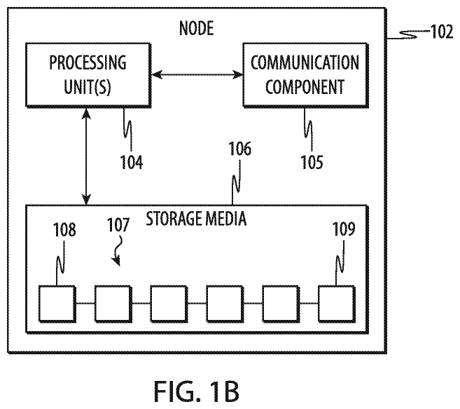

These and other embodiments are discussed below with reference to FIGS. 1A-7. However, those skilled in the art will readily appreciate that the detailed description given herein with respect to these Figures is for explanatory purposes only and should not be construed as limiting.

FIG. 1A depicts an example of a blockchain network system 100. The system 100 may include a blockchain network 101 that has multiple nodes 102 configured in a peer-to-peer configuration. Each node 102 may store a copy of a blockchain. The nodes 102 may execute a software protocol for communicating with other nodes 102 in order to come to a consensus about validating new transactions, adding new validated transactions to the blockchain, and propagating the updated blockchain to the other nodes 102. The system 100 may be open, allowing any kind of computing device that can be configured to communicate using the appropriate protocol to be a node 102.

The system 100 may also include one or more client devices 103. The client device 103 may communicate with the system 100 in order to submit transactions, query the blockchain, and so on. The client device 103 may communicate with the system 100 as part of one or more digital currency applications, land title applications, escrow applications, banking applications, information storage applications, payment applications, invoicing applications, retailer system applications, and so on.

FIG. 1B depicts an example of functional relationships between components of a node 102 that may be used in the blockchain network system 100 of FIG. 1A. The node 102 may be any kind of computing device, such as a desktop computing device, a laptop computing device, a mobile computing device, a tablet computing device, a wearable device, a cellular telephone, a digital media player, and so on. The node 102 may include one or more processing units 104 or other processors or controllers, one or more communication components 105, one or more non-transitory storage media 106 (which may take the form of, but is not limited to, a magnetic storage medium; optical storage medium; magneto-optical storage medium; read only memory; random access memory; erasable programmable memory; flash memory; and so on), and so on. The processing unit 104 may execute instructions stored in the non-transitory storage medium 106 in order to perform one or more functions, such as communicating with other computing devices, validating transactions, searching for blocks, and so on.

A complete copy of a blockchain 107 may be stored in the non-transitory storage medium 106. The blockchain 107 may include a number of blocks, such as an initial or “genesis” block 108 and a most recent block 109.

Although the system 100 is illustrated and described as a particular configuration of a blockchain network system, it is understood that this is an example. Blockchain network systems may be configured in a variety of different arrangements.

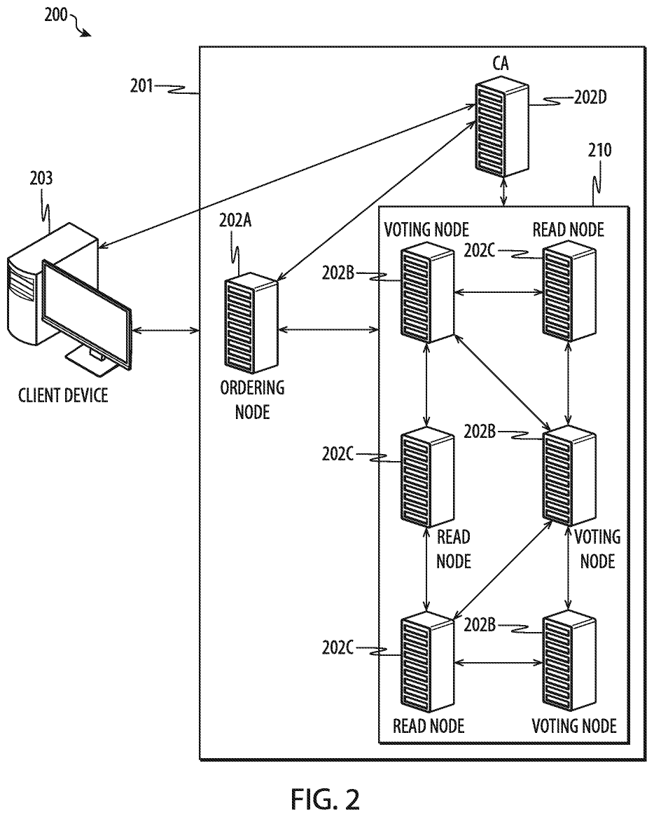

For example, FIG. 2 depicts an example of a hyperledger fabric blockchain network system 200. The hyperledger fabric blockchain network system 200 may include a hyperledger fabric blockchain network 201 and one or more client devices 203. The hyperledger fabric blockchain network 201 may include one or more ordering nodes 202A, a group of peer nodes 210 that include one or more voting nodes 202B and read nodes 202C, and one or more certificate authority devices 202D.

The group of peer nodes 210 may be directed by the ordering node 202A. For example, transactions received by the hyperledger fabric blockchain network 201 related to a blockchain may be directed by the ordering node 202A to the voting nodes 202B. The voting nodes 202B may come to a consensus about whether or not to validate the transaction in order to add the transaction to the blockchain according to the software protocol by which the hyperledger fabric blockchain network 201 operates. Voting nodes 202B may also store a copy of the blockchain and may be able to respond to requests to search and/or read blocks of the blockchain. Read nodes 202C may store a copy of the blockchain and be able to respond to requests to search and/or read blocks of the blockchain without any role in validating transactions.

Unlike the permission-less arrangement of the system 100 of FIG. 1A, device participation in the hyperledger fabric blockchain network 201 may be controlled. Devices may need to obtain a certificate or similar credential by communicating with the certificate authority device 202D in order to perform a role as an ordering node 202A, a voting node 202B, and/or a read node 202C.

Blockchain networks may use a variety of technologies to work with portions of the blockchain rather than the entirety. For example, the hyperledger fabric blockchain network 201 may use hyperledger channels. A hyperledger channel may function as a private “subnet” of communication between two or more members of the hyperledger fabric blockchain network 201. The channel may be identified by memberships, nodes of the group of peer nodes 210 that belong to those memberships, the shared portion of the blockchain corresponding to the channel (including the genesis block of the channel, regardless whether or not that block is the actual genesis block of the blockchain itself), chaincode application(s), and the ordering node(s) 202A. Transactions on the hyperledger fabric blockchain network 201 may be executed on the channel. If so, each member may need to be authenticated to transact on the channel. Each node of the group of peer nodes 210 that joins the channel may have its own identity given by a membership services provider. The membership services provider may authenticate each node that joins to its channel peers and services. Configuration information about the channel policies, memberships, and anchor peers may be stored, such as in the genesis block of the channel. Hyperledger channels may be used to provide segmented permissions to different portions of the blockchain and/or to different entities.

Another technology that may be used is to implement the blockchain as a number of segments. The segments may be separate, essentially functioning as separate chains. In some embodiments, the segments may be implemented using technologies similar to those used to implement channels. Each segment may form a different portion of the blockchain, though some segments may overlap. In this way, by forming a blockchain out of a number of segments rather than a single segment, individual segments may be searched rather than the entire blockchain. As blockchains are typically searched from a most recently added block backwards, being able to search from the most recent block of an individual segment rather than the most recent block of the entire blockchain may allow the search to skip searching a great deal of the blockchain in order to find the searched block.

When certain conditions occur, a branch may be created on a segment. A branch may mirror a portion of the most recent portion of the segment but additional sets of data added to the segment may not also be added to the branch. After the additional set of data is added to the segment, the branch may be used instead of the last block of the additional set of data to search the segment without searching back through the additional set of data. This may further improve search time.

As discussed herein, segments may also be used to improve blockchain access speed in the hyperledger fabric blockchain network 201 (or another blockchain network, such as the blockchain network 101 of FIG. 1A). When the blockchain is first created, the hyperledger fabric blockchain network 201 may create a segment for the blockchain and read and/or write to the blockchain using the segment. When various conditions occur, the hyperledger fabric blockchain network 201 may archive or close the segment and create a new segment. Thus, each segment may correspond to a portion of the blockchain of a certain time/date or a block number range. Time/date or block number may be part of the key used to search for a block. As such, the hyperledger fabric blockchain network 201 may use the time/date or the block number for a read and/or a write to select the segment where that time/date or block number may be found. The hyperledger fabric blockchain network 201 may then search using the selected segment. This may be faster than searching the entire blockchain, particularly as the size of the blockchain increases.

Further, when certain conditions occur, the hyperledger fabric blockchain network 201 may create a branch on a segment. The branch may mirror a portion of the most recent portion of the segment but the hyperledger fabric blockchain network 201 may not add additional sets of data added to the segment onto the branch. After the hyperledger fabric blockchain network 201 adds the additional set of data to the segment, the hyperledger fabric blockchain network 201 may use the branch instead of the last block of the additional set of data to search the segment. This may allow the hyperledger fabric blockchain network 201 to avoid searching back through the additional set of data and may further improve search time.

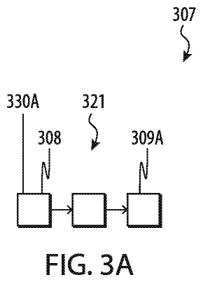

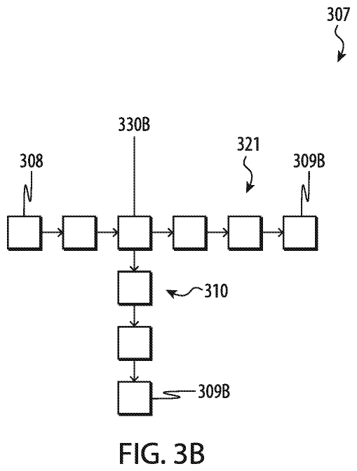

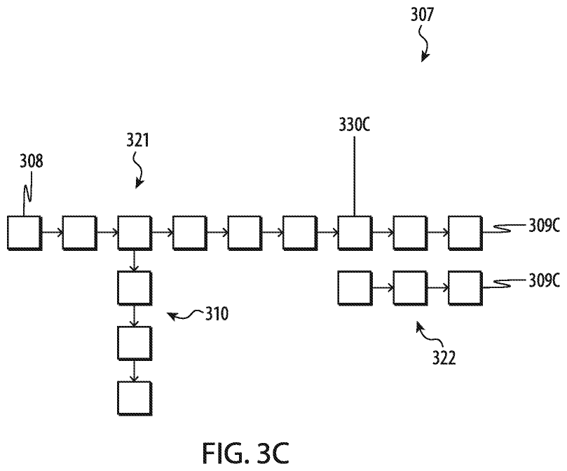

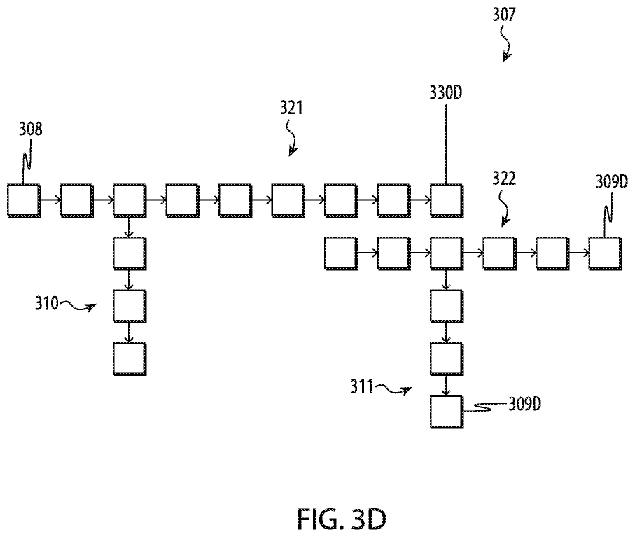

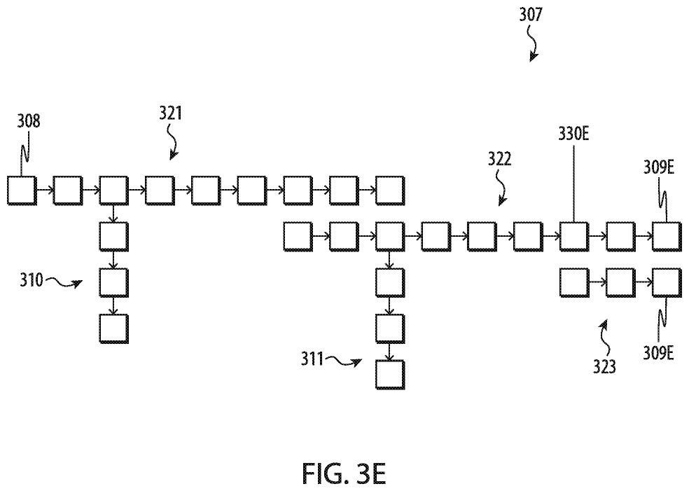

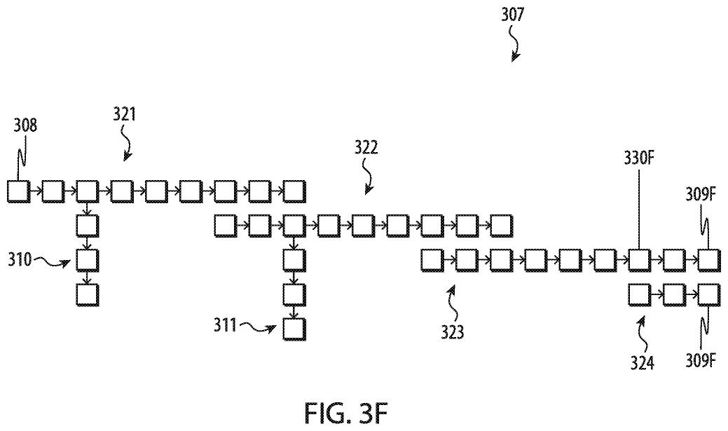

FIG. 3A depicts an example blockchain 307 including a first segment 321 created or opened at a first time 330A by a blockchain network, such as the blockchain network 101 of FIG. 1A or the hyperledger fabric blockchain network 201 of FIG. 2. As shown, the blockchain 307 includes a genesis block 308. The genesis block 308 is linked to a number of other blocks, terminating in a most recent block 309A. The blockchain network may read from and/or write to the blockchain 307 by reading from and/or writing to the first segment 321. The blockchain network may search the blockchain 307 by searching backwards from the most recent block 309A.

FIG. 3B depicts the blockchain of FIG. 3A after the blockchain network adds a first additional set of data and a branch 310 to the first segment 321 at a second time 330B. This creates a new most recent block 309B at the end of the first segment 321. The branch 310 mirrors the first additional set of data added to the first segment 321, also terminating in the most recent block 309B.

FIG. 3C depicts the blockchain of FIG. 3B after the blockchain network adds a second additional set of data to the first segment 321 and creates a second segment 322 at a third time 330C. This creates a new most recent block 309C at the end of the first segment 321 but not the branch 310. The second segment 322 includes the second additional set of data, also terminating in the most recent block 309C.

The first segment 321 corresponds to the entire blockchain 307 and the second segment 322 corresponds to the portion of the blockchain 307 from the third time 330C to the most recent block 309C. The blockchain network may search or access the entire blockchain 307 (or block numbers corresponding thereto) by searching or accessing the first segment 321. The blockchain network may search or access the portion of the blockchain 307 prior to the third time 330C by searching or accessing the branch 310. The blockchain network may search or access the portion of the blockchain 307 from the third time 330C to the most recent block 309C by searching or accessing the second segment 322.

FIG. 3D depicts the blockchain of FIG. 3C after the blockchain network archives or closes the first segment 321 and adds a third additional set of data and a branch 311 to the second segment 322 at a fourth time 330D. This creates a new most recent block 309D at the end of the second segment 322. The branch 311 mirrors the third additional set of data added to the second segment 322, also terminating in the most recent block 309D.

FIG. 3E depicts the blockchain of FIG. 3D after the blockchain network adds a fourth additional set of data to the second segment 322 and creates a third segment 323 at a fifth time 330E. This creates a new most recent block 309E at the end of the second segment 322 but not the branch 311. The third segment 323 includes the fourth additional set of data, also terminating in the most recent block 309E.

The second segment 322 corresponds to the portion of the blockchain 307 from the third time 330C to the most recent block 309E. The third segment 323 corresponds to the portion of the blockchain 307 from the fifth time 330E to the most recent block 309E. The blockchain network may search or access the portion of the blockchain 307 from the third time 330C to the most recent block 309E by searching or accessing the second segment 322. The blockchain network may search or access the portion of the blockchain 307 between the third time 330C to the fifth time 330E by searching or accessing the branch 311. The blockchain network may search or access the portion of the blockchain 307 from the fifth time 330E to the most recent block 309E by searching or accessing the third segment 323.

FIG. 3F depicts the blockchain of FIG. 3E after the blockchain network archives or closes the second segment 322 and adds a fifth additional set of data to the third segment 323 and creates or opens a fourth segment 324 at a sixth time 330F. This creates a new most recent block 309F at the end of the third segment 323. The fourth segment 324 includes the fifth additional set of data, also terminating in the most recent block 309F.

The third segment 323 corresponds to the portion of the blockchain 307 from the fifth time 330E to the most recent block 309F. The fourth segment 324 corresponds to the portion of the blockchain 307 from the sixth time 330F to the most recent block 309F. The blockchain network may search or access the portion of the blockchain 307 from the fifth time 330E to the most recent block 309F by searching or accessing the third segment 323. The blockchain network may search or access the portion of the blockchain from the sixth time 330F to the most recent block 309F by searching or accessing the fourth segment 324.

Thus, after the first three events that trigger (or the occurrence of the first three “triggering conditions”) creation of a new segment, there may always be at least one current segment, one previous segment, and at least one archive segment. Triggering events may include an elapse of a period of time (such as the time period between the first time 330A and the third time 330C, between the third time 330C and the fifth time 330E, or between the fifth time 330E and the sixth time 330F; which may be the same period of time or different periods of time), a size of the blockchain 307 and/or the segments 321-324 exceeding a threshold size (such as one gigabyte), a combination of these, and so on.

As shown, no branch is added to the third segment 323. In this example, branches may not be added to all segments. Branches may be added based on a variety of different conditions. Such conditions may include expiration of a different time period from creation or opening of a new segment, size of a segment reaching a size threshold (such as five hundred megabytes), and so on. Various configurations are possible and contemplated without departing from the scope of the present disclosure.

From the state of the blockchain 307 and the segments 321-324 shown in FIG. 3F, the blockchain network may select one of the segments 321-324 or the branches 310, 311 when searching for blocks of the blockchain 307 based on a date, time, or block number within a range associated with one or more of the segments 321-324 or the branches 310, 311. Due to the fewer number of blocks that may be searched in this way compared to the entire blockchain 307, this may improve search time. As such, the efficiency and resource consumption may be improved.

As shown and described above, the segments 321-324 may overlap with each other. For example, the second segment 322 overlaps with the first segment 321 (its previous segment) and the third segment 323 (its subsequent segment). This may ensure that links between blocks are not cut off between segments 321-324. This may also allow for different ranges of times/dates or block numbers to be searched without having to use multiple segments 321-324. This may also ensure that data related to transactions are not cut off between segments, which could result in the inability to access or use the data. However, it is understood that this is an example. In various implementations, segments may not overlap.

Further, the overlapping is shown and described as having a gap between the first segment 321 and the third segment 323 and between the second segment 322 and the fourth segment 324. However, it is understood that this is an example. In some implementations, a segment may be archived or closed when the second subsequent segment is created or opened in order to ensure greater data redundancy. In such a case, the blockchain 307 could be represented entirely by the first segment 321 and the third segment 323 even if the second segment 322 and the fourth segment 324 were removed. Various configurations are possible and contemplated without departing from the scope of the present disclosure.

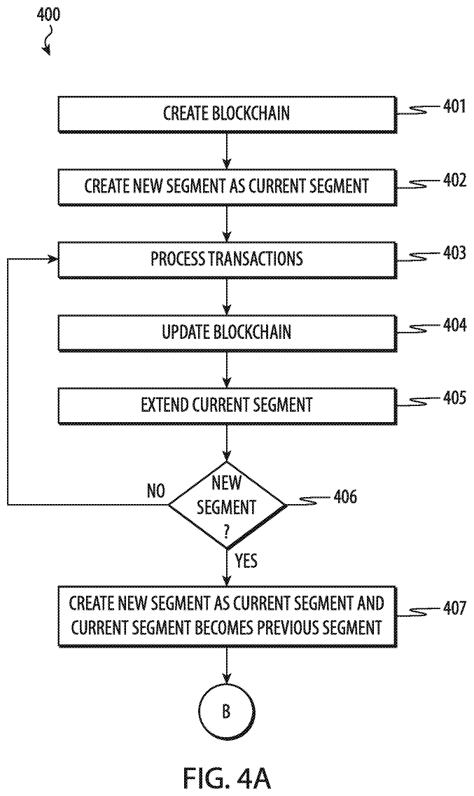

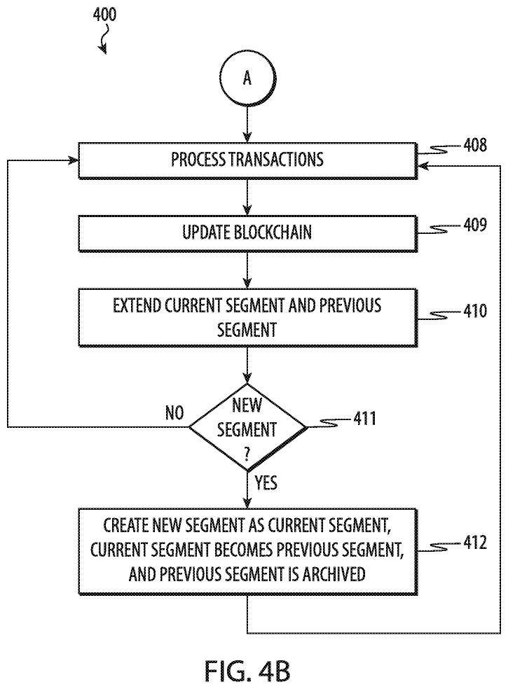

FIGS. 4A and 4B depict a flow chart illustrating a first example method 400 for using segments in a blockchain network. This method 400 may be performed by the systems 100, 200 of FIG. 1A or 2.

The flow begins at 401 where a blockchain network is created. The flow then proceeds to 402 where a new segment is created as a current segment. Next, the flow proceeds to 403 where transactions are processed. The flow then proceeds to 404 where the blockchain is updated for the processed transactions. Next, the flow proceeds to 405 where the current segment is extended based on the updated blockchain and the processed transactions.

Although the method 400 is illustrated and described as updating the blockchain and extending the current segment based on the processed transactions sequentially at 404 and 405, it is understood that this is an example. Updating the blockchain and extending the segment may be part of the same operation rather than separate operations.

From 405, the flow proceeds to 406 where it is determined whether or not to create a new segment. If so, the flow proceeds to 407. Otherwise, the flow returns to 403 where additional transactions are processed.

At 407, after it is determined to create a new segment, a new segment is created as the current segment and the previously current segment becomes the previous segment.

The flow then proceeds to 408 where transactions are processed. The flow then proceeds to 409 where the blockchain is updated for the processed transactions. Next, the flow proceeds to 410 where the current segment and the previous segment are extended based on the updated blockchain and the processed transactions.

The flow proceeds to 411 where it is determined whether or not to create a new segment. If so, the flow proceeds to 412. Otherwise, the flow returns to 408 where additional transactions are processed.

At 412, after it is determined to create a new segment, a new segment is created as the current segment, the previously current segment becomes the previous segment, and the previously previous segment is archived or closed. The flow then returns to 408 where additional transactions are processed.

Although the example method 400 is illustrated and described as including particular operations performed in a particular order, it is understood that this is an example. In various implementations, various orders of the same, similar, and/or different operations may be performed without departing from the scope of the present disclosure.

For example, in some implementations, operations 404 and 405 and/or 409 and 410 may be different aspects of the same action rather than separate operations. Various configurations are possible and contemplated.

By way of another example, the method 400 illustrates and describes creating or opening new segments but does not involve adding branches to segments. However, in various implementations, determinations may be made regarding whether or not to add one or more branches to one or more segments. Such a determination may be made based on the expiration of one or more time periods, sizes of segments, and so on. Various configurations are possible and contemplated.

The determination to create a new segment at 406 and/or 411 may be performed according to a variety of different criteria. In various implementations, new segments may be created at 406 and/or 411 if one or more time periods have elapsed. In some examples, the time periods may be uniform. In other examples, the time periods may have different durations.

In other implementations, new segments may be created at 406 and/or 411 if the size of a current or previous segment or the blockchain itself exceeds a size threshold. In still other implementations, new segments may be created at 406 and/or 411 if the size of a current or previous segment or the blockchain itself is determined to exceed a size threshold after one or more time periods have elapsed. Various configurations are possible and contemplated.

In various examples, this example method 400 may be implemented as a group of interrelated software modules or components that perform various functions discussed herein. These software modules or components may be executed by one or more computing devices, such as one or more of the node 102 of FIGS. 1A-1B or the ordering node 202A, the voting node 202B, and/or the read node 202C of FIG. 2.

For example, in one embodiment, a system for using segments to improve access speed in a blockchain network includes at least one non-transitory storage medium that stores instructions and at least one processor. The at least one processor executes the instructions to create a first segment for a blockchain; upon occurrence of a triggering condition, create a second segment for the blockchain, the second segment associated with a different portion of the blockchain than the first segment; receive a search query for the blockchain that is associated with a date or a block number; and select the first segment or the second segment to search using the date or the block number of the search query.

In some examples, the triggering condition is expiration of a time period. In various implementations of such an example, the time period is approximately three months. In other examples, the triggering condition is a size of the first segment exceeding a size threshold. In some implementations of such an example, the at least one processor checks if the size of the first segment exceeds the size threshold upon expiration of a time period.

In various examples, upon occurrence of an additional triggering condition, the at least one processor creates a third segment for the blockchain that is associated with a first portion of the blockchain that is associated with the first segment and a second portion of the blockchain that is associated with the second segment. In some examples, upon occurrence of an additional triggering condition, the at least one processor adds a branch to the first segment prior to adding a set of data to the first segment. The at least one processor may be operable to search the first segment prior to the set of data using the branch.

By way of another example, in another embodiment, a system for using segments to improve access speed in a blockchain network may include at least one non-transitory storage medium that stores instructions and at least one processor. The at least one processor executes the instructions to create a first segment associated with a first portion of a blockchain; at a first time, create a second segment associated with a second portion of the blockchain that is subsequent to the first time; at a second time, create a third segment associated with a third portion of the blockchain that is subsequent to the second time; close the first segment so the first portion of the blockchain is previous to the second time; receive a query for a block of the blockchain; and select the first segment, the second segment, or the third segment to search for the block using data specified in the query.

In various examples, the first segment overlaps the second segment and the second segment overlaps the third segment. In some examples, the at least one processor creates a fourth segment associated with a fourth portion of the blockchain at a fourth time and closes the second segment so the second portion of the blockchain is previous to the fourth time.

In numerous examples, the first time is a first period of time after the first segment is created and the second time is a second period of time after the first time. In various implementations of such examples, the first period of time is equal to the second period of time. In other implementations of such examples, the first period of time and the second period of time have different durations.

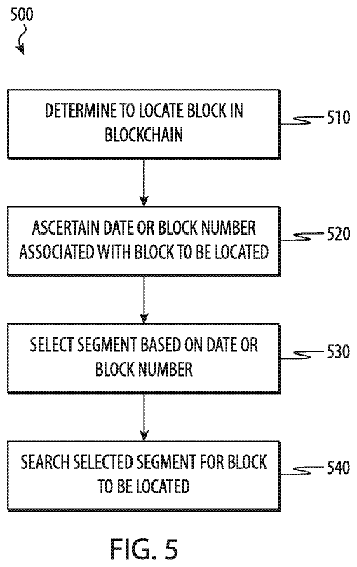

FIG. 5 depicts a flow chart illustrating an example method 500 for searching in a blockchain network that uses segments. This method 500 may be performed by the systems 100, 200 of FIG. 1A or 2. This method 500 may be performed using a set of multiple segments that correspond to a time/date or block number range portion of a blockchain, such as the blockchains and corresponding segments detailed above with respect to FIGS. 3A-3F and 4A-4B.

The flow begins at 501 where it is determined to locate a block in a blockchain. It may be determined to locate the block in order to read the data of the block, to write data to the block, and so on. The flow then proceeds to 520 where a date and/or time or block number associated with the block to be located is ascertained. Next, the flow proceeds to 530 where a segment is selected based on the date, time, and/or block number. The flow then proceeds to 540 where the selected segment is searched for the block to be located.

Although the example method 500 is illustrated and described as including particular operations performed in a particular order, it is understood that this is an example. In various implementations, various orders of the same, similar, and/or different operations may be performed without departing from the scope of the present disclosure.

For example, the method is illustrated and described at 530 as selecting the segment based on the date, time, and/or block number. In some implementations, more than one segment may be selectable based on the date, time, and/or block number. For example, in implementations like those detailed above with respect to FIGS. 3A-3F and 4A-4B, segments may overlap and either of the overlapping segments may be selected. In such implementations, various data may be evaluated to determine which of the overlapping segments to select.

For example, if the date, time, and/or block number would be found in either and the overlapping segments have different sizes, the smaller of the two segments may be selected. By way of another example, if a block is part of a block sequence that is to be searched for, the segment that will contain more of the range of block sequence may be selected. Various configurations are possible and contemplated without departing from the scope of the present disclosure.

By way of another example, the method 500 illustrates and describes selecting among segments but does not involve considering branches of segments. However, in various implementations, one or more branches of a segment may be selected instead of the segment itself. Various configurations are possible and contemplated.

In various examples, this example method 500 may be implemented as a group of interrelated software modules or components that perform various functions discussed herein. These software modules or components may be executed by one or more computing devices, such as one or more of the node 102 of FIGS. 1A-1B or the ordering node 202A, the voting node 202B, and/or the read node 202C of FIG. 2.

For example, in one embodiment, a system for using segments to improve access speed in a blockchain network may include at least one non-transitory storage medium and at least one processor. The non-transitory storage medium may store instructions and a group of segments that each correspond to different portions of a blockchain. The at least one processor may execute the instructions to receive a query to search for a block of the blockchain, select a segment of the group of segments using a date or a block number corresponding to the query, and search the segment of the group of segments for the block.

In some examples, the group of segments correspond to all of the blockchain. In various examples, the group of segments overlap each other.

In numerous examples, the different portions all have a same duration. In various examples, the different portions all have a same size.

In some examples, at least one of the group of segments is an archive segment. In various examples, the query is a read query or a write query.

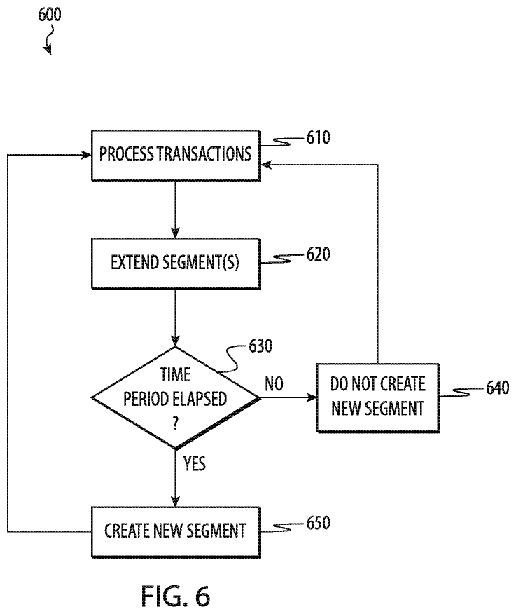

FIG. 6 depicts a flow chart illustrating a second example method 600 for using segments in a blockchain network. This method 600 may be performed by the systems 100, 200 of FIG. 1A or 2.

At 610, transactions are processed. The flow then proceeds to 620 where one or more segments are extended and a corresponding blockchain is updated for the processed transactions. Next, the flow proceeds to 630 where it is determined whether or not a time period is elapsed. For example, the time period may be three months. If the time period has not elapsed, the flow proceeds to 640 where it is determined to not create a new segment before the flow returns to 610 and additional transactions are processed. Otherwise, the flow proceeds to 650 where a new segment is created before the flow returns to 610 and additional transactions are processed.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as creating a new segment at 650. In various implementations, 650 may also involve changing the status of an existing segment from current to previous, from previous to archived, and so on. Various configurations are possible and contemplated without departing from the scope of the present disclosure.

By way of another example, the method 600 illustrates and describes creating or opening new segments but does not involve adding branches to segments. However, in various implementations, one or more branches may be added to one or more segments. Various configurations are possible and contemplated.

In various examples, this example method 600 may be implemented as a group of interrelated software modules or components that perform various functions discussed herein. These software modules or components may be executed by one or more computing devices, such as one or more of the node 102 of FIGS. 1A-1B or the ordering node 202A, the voting node 202B, and/or the read node 202C of FIG. 2.

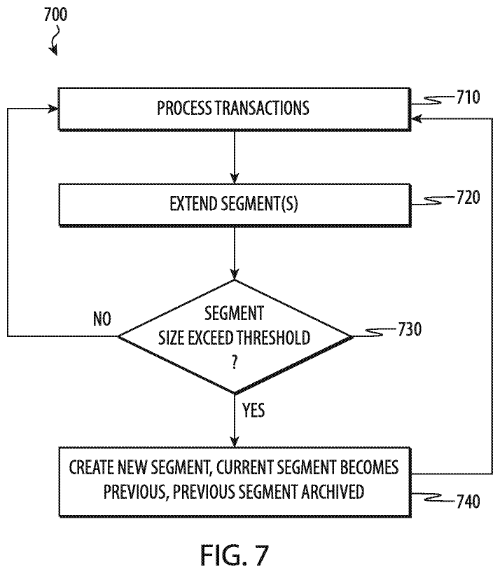

FIG. 7 depicts a flow chart illustrating a third example method 700 for using segments in a blockchain network. This method 700 may be performed by the systems 100, 200 of FIG. 1A or 2.

At 710, transactions are processed. The flow then proceeds to 720 where one or more segments are extended and a corresponding blockchain is updated for the processed transactions. Next, the flow proceeds to 730 where it is determined whether or not the size of the one or more segments exceeds a threshold. For example, the threshold may be 300 megabytes. If so, the flow proceeds to 740 where a new segment is created before the flow returns to 710 and additional transactions are processed. Otherwise, the flow returns to 710 and additional transactions are processed.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as evaluating whether or not the segment size exceeds the threshold at 730. However, in various implementations, the size of the segment may be evaluated to see if it exceeds the threshold upon the elapse of a time period, such as one week. Various configurations are possible and contemplated without departing from the scope of the present disclosure.

In various examples, this example method 700 may be implemented as a group of interrelated software modules or components that perform various functions discussed herein. These software modules or components may be executed by one or more computing devices, such as one or more of the node 102 of FIGS. 1A-1B or the ordering node 202A, the voting node 202B, and/or the read node 202C of FIG. 2.

As described above and illustrated in the accompanying figures, the present disclosure relates to blockchain networks that use segments for faster access. When the blockchain is first created, the network may create a first segment for the blockchain and read and/or write to the segment. When various conditions occur, the network may archive the segment and create a new segment. Thus, each segment may correspond to a portion of the blockchain of a certain time/date or block number range. As time/date or block number may be part of the key used to search for a block, the network may use the time/date or block number for a read and/or a write to select the segment where that time/date may be found. The network may search using the selected segment. Thus, by searching a segment rather than the entire blockchain each time, the network may be able to perform reads and/or writes significantly faster. This may greatly increase the response time of the network, as well as improving efficiency and reducing resources that are consumed by the network. This unconventional application of segments may address the blockchain network technology centered problem of large blockchain searching time that is in fact created by an overwhelming amount of data made possible by the blockchain network. When certain conditions occur, the network may create a branch on a segment, mirroring a portion of the most recent portion of the segment. When an additional set of data is added to the segment, the branch may be used instead of the last block of the additional set of data to search the segment without searching back through the additional set of data. This may further improve search time.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for using segments to improve access speed in a blockchain network, comprising:
at least one non-transitory storage medium that stores instructions; and
at least one processor that executes the instructions to:
create a first segment for a blockchain;
upon occurrence of a triggering condition, create a second segment for the blockchain, the second segment associated with a different portion of the blockchain than the first segment;
receive a search query for the blockchain that is associated with a date or a block number; and
select the first segment or the second segment to search using the date or the block number of the search query.

2. The system of claim 1, wherein the triggering condition comprises expiration of a time period.

3. The system of claim 2, wherein the time period is approximately three months.

4. The system of claim 1, wherein the triggering condition comprises a size of the first segment exceeding a size threshold.

5. The system of claim 4, wherein the at least one processor checks if the size of the first segment exceeds the size threshold upon expiration of a time period.

6. The system of claim 1, wherein, upon occurrence of an additional triggering condition, the at least one processor creates a third segment for the blockchain, the third segment associated with:
a first portion of the blockchain that is associated with the first segment; and
a second portion of the blockchain that is associated with the second segment.

7. The system of claim 1, wherein, upon occurrence of an additional triggering condition, the at least one processor adds a branch to the first segment prior to adding a set of data to the first segment, the at least one processor operable to search the first segment prior to the set of data using the branch.

8. A system for using segments to improve access speed in a blockchain network, comprising:
at least one non-transitory storage medium that stores:
instructions; and
a group of segments that each correspond to different portions of a blockchain; and
at least one processor that executes the instructions to:
receive a query to search for a block of the blockchain;
select a segment of the group of segments using a date or a block number corresponding to the query; and
search the segment of the group of segments for the block.

9. The system of claim 8, wherein the group of segments correspond to all of the blockchain.

10. The system of claim 8, wherein the group of segments overlap each other.

11. The system of claim 8, wherein the different portions all have a same duration.

12. The system of claim 8, wherein the different portions all have a same size.

13. The system of claim 8, wherein at least one of the group of segments is an archive segment.

14. The system of claim 8, wherein the query is a read query or a write query.

15. A system for using segments to improve access speed in a blockchain network, comprising:
at least one non-transitory storage medium that stores instructions; and
at least one processor that executes the instructions to:
create a first segment associated with a first portion of a blockchain;
at a first time, create a second segment associated with a second portion of the blockchain that is subsequent to the first time;
at a second time, create a third segment associated with a third portion of the blockchain that is subsequent to the second time;
close the first segment so the first portion of the blockchain is previous to the second time;
receive a query for a block of the blockchain; and
select the first segment, the second segment, or the third segment to search for the block using data specified in the query.

16. The system of claim 15, wherein the first segment overlaps the second segment and the second segment overlaps the third segment.

17. The system of claim 15, wherein the first time is a first period of time after the first segment is created and the second time is a second period of time after the first time.

18. The system of claim 17, wherein the first period of time is equal to the second period of time.

19. The system of claim 17, wherein the first period of time and the second period of time have different durations.

20. The system of claim 15, wherein the at least one processor:
creates a fourth segment associated with a fourth portion of the blockchain at a fourth time; and
closes the second segment so the second portion of the blockchain is previous to the fourth time.
